(19) United States
(12) Patent Application Publication
(10) Pub. No.: US 2015/0117477 A1
(43) Pub. Date: Apr. 30, 2015

(54) LASER APPARATUS AND METHOD FOR GENERATING OPTICAL PULSES BASED ON Q-SWITCHING MODULATED WITH A 2-D SPATIAL LIGHT MODULATOR

(71) Applicant: Lockheed Martin Corporation, Bethesda, MD (US)

(72) Inventor: Edward Jozef Miesak, Windermere, FL (US)

(73) Assignee: Lockheed Martin Corporation, Bethesda, MD (US)

(21) Appl. No.: 14/065,600

(22) Filed: Oct. 29, 2013

(51) Int. Cl. H01S 3/115

(52) U.S. Cl. CPC H01S 3/115
USPC 372/12

(57) ABSTRACT

A laser apparatus and method are provided for generating optical pulses based on Q-switching controllable with a fast and reliable two-dimensional (2-D) spatial light modulator, such as a digital micro-mirror device (DMD). Temporal and spatial modulation may be applied to selectively control the Q-switching provided by the spatial light modulator. The apparatus and method may be optionally optimized with straightforward optical components to increase angular magnification of a beam incident on the spatial light modulator and thus effectively reduce the Q-switching time.

### BACKGROUND

Embodiments relate to Q-switching, and, more particularly, to a laser apparatus and method for generating optical pulses based on Q-switching controllable with a two-dimensional (2-D) spatial light modulator.

Q-switching, sometimes referred to as giant pulse formation, is a technique by which a laser can be configured to generate a pulsed output beam. The technique allows generation of light pulses having relatively high peak power, much higher than would be produced by the same laser if it were operating in a continuous wave (constant output) mode. Some switches involve mechanical designs that inhibit laser action during the optical pumping cycle by blocking the light path, causing a mirror misalignment, or reducing the reflectivity of one of the resonator mirrors in the laser cavity. For example, at some point of a flashlamp pulse, when maximum energy has been stored in a laser rod, a high Q-condition may be established and a Q-switch pulse is emitted from the laser. Mechanical Q-switches are relatively slow and bulky. Moreover, mechanical wear generally requires burdensome and costly maintenance. Electro-optic or acousto-optic devices have been proposed for Q-switching. However, some of these devices may suffer from certain drawbacks for infrared applications, such as applications in the mid-wavelength infrared (MWIR) frequency range. Accordingly, there continues to be a need for improved laser apparatuses and/or techniques useful for generation of optical pulses based on Q-switching.

### SUMMARY

Embodiments relate to a laser apparatus and method for generating optical pulses. The laser apparatus may comprise a laser cavity and a spatial light modulator including a two dimensional array of pixels arranged to provide Q-switching at a pixel level in the laser cavity. A controller is connected to the spatial light modulator (SLM) to temporally and spatially modulate the two-dimensional array of pixels to selectively control the Q-switching provided by the spatial light modulator.

The method allows performing Q-switching at a pixel level in a laser cavity with a spatial light modulator comprising a two-dimensional array of pixels. Temporal and spatial modulation of the two-dimensional array of pixels with a controller allows selectively controlling the Q-switching performed by the spatial light modulator.

### BRIEF DESCRIPTION OF THE DRAWINGS

Embodiments may be explained in the following description in view of the drawings that show:

FIG. 1 is a schematic representation of an embodiment of a laser apparatus for generating optical pulses based on Q-switching controllable with a spatial light modulator, such as may include a 2-D array of rotatable pixel micro-mirrors.

FIGS. 2-5 are respective schematic representations of embodiments that may utilize one or more non-curved optical elements to provide angular magnification to a beam incident on the two-dimensional array of micro-mirrors.

FIGS. 6-8 are respective schematic representations of embodiments that may utilize a telescopic arrangement to provide angular magnification and further allow spreading a cross-section of a beam incident on the two-dimensional array of micro-mirrors.

FIG. 9 illustrates non-limiting examples of pulse profiles that can be generated with a laser apparatus embodying the disclosed Q-switching.

### DETAILED DESCRIPTION

The present inventor has cleverly recognized certain limitations in connection with known laser apparatuses and techniques for generating optical pulses based on Q-switching. It is believed that fast and reliable Q-switches are presently not available for Q-switching applications in the mid-wavelength infrared (MWIR) frequency range. For example, such Q-switches are relatively slow or prone to unreliable operation. In view of such recognition, the present inventor proposes innovative laser apparatus and method for reliably and cost-effectively generating optical pulses based on Q-switching controllable with a fast and reliable two-dimensional (2-D) spatial light modulator. The apparatus and method may be optionally optimized with straightforward optical components to increase angular magnification of a beam incident on the spatial light modulator and thus effectively reduce the Q-switching time. For readers desirous of general background information in connection with Q-switching, reference is made to chapter 8 (Q-Switching) of textbook titled “Solid State Lasers: A Graduate Text” by Walter Koechner and Michael Bass, © 2003 Springer-Verlag New York, Inc., which is incorporated by reference herein.

In the following detailed description, various specific details are set forth in order to provide a thorough understanding of depicted embodiments. However, those skilled in the art will understand that such embodiments may be practiced without these specific details; that the depicted embodiments are non-limiting embodiments; and that alternative embodiments may be implemented. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding the embodiments. However, the order of description should not be construed as to imply that these operations need be performed in the order they are presented, nor that they are even order dependent unless otherwise do described. Moreover, repeated usage of the phrase “in one embodiment” does not necessarily refer to the same embodiment, although it may. Lastly, the terms “comprising”, “including”, “having”, and the like, as used in the present application, are intended to be synonymous unless otherwise so indicated.

Embodiments relate to a laser apparatus and method for generating optical pulses. The laser apparatus may comprise a laser cavity and a spatial light modulator including a two-dimensional array of pixels arranged to provide Q-switching at a pixel level in the laser cavity. A controller is connected to the spatial light modulator to temporally and spatially modulate the two-dimensional array of pixels to selectively control the Q-switching provided by the spatial light modulator.

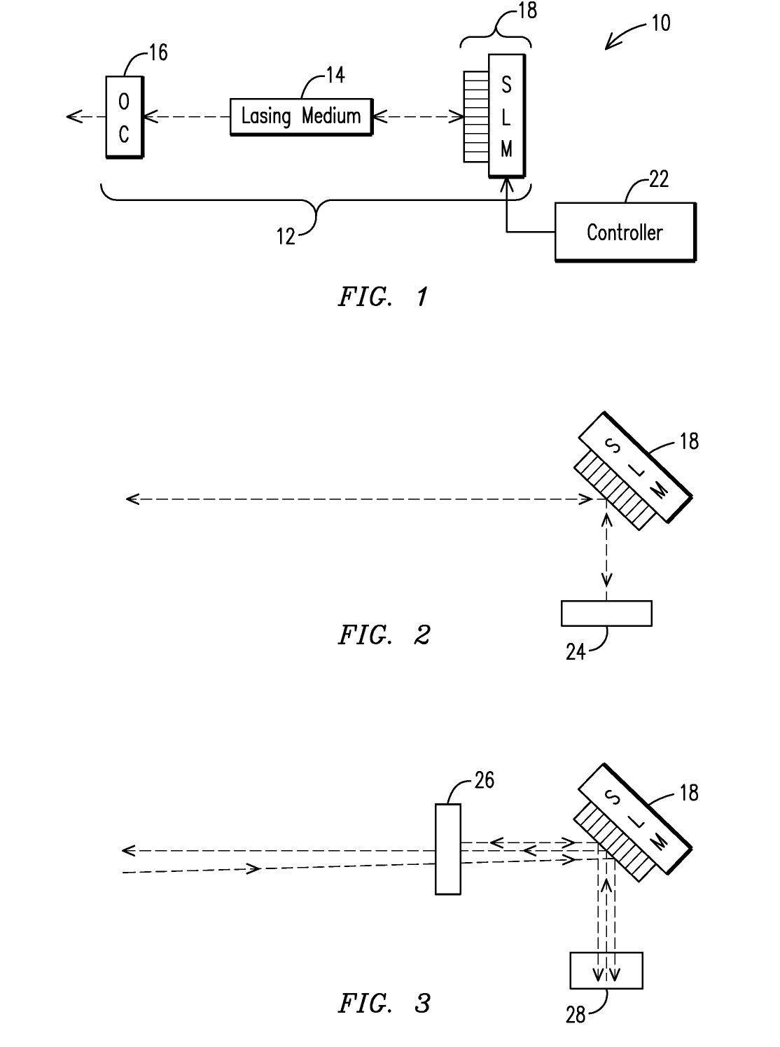

FIG. 1 is a schematic representation of an embodiment of a laser apparatus 10 for generating optical pulses based on controllable Q-switching. Apparatus 10 includes a laser cavity 12 in which laser radiation can pass through an appropriate lasing medium 14, such as a solid state lasing medium. Non-limiting examples of lasing media may be Nd:YAG (Neodymium doped Yttrium Aluminum Garnet); Er:YAG (Erbium doped Yttrium Aluminum Garnet); Yb:YAG (Ytterbium doped Yttrium Aluminum Garnet); Cr, Tm, Ho:YAG (Chromium, Thulium, Holmium doped Yttrium Aluminum Garnet; Er, Cr:YSGG (Erbium, Chromium doped Yttrium Scandium Gallium Garnet), etc.

As will be appreciated by one skilled in the art, one end of laser cavity 12 includes an output coupler (OC) 16, which may be a partially transmissive mirror. A spatial light modulator (SLM) 18 is disposed at an opposite end of laser cavity 12 to provide Q-switching by way of a two-dimensional (2-D) array (e.g., 1024×768) of individually-addressable, tiltable micro-mirror pixels. One non-limiting example of such a device is known in the art as a digital micro-mirror device (DMD) available front Texas Instruments Incorporated. For readers desirous of general background information in connection with DMD technology, reference is made to Application Report DLPA008, titled “introduction to Digital Micromirror Device (DMD) Technology”, © 2008 Texas Instrument incorporated, which is incorporated by reference herein.

A controller 22 is connected to spatial light modulator 18 to temporally and spatially modulate the two-dimensional array of pixels to selectively control the Q-switching provided by spatial light modulator 18. SLM 18 may be used as a switching device for controlling Q-switching at a pixel level in the laser cavity. Essentially, each pixel can function as an individualized Q-switch and the aggregate response may be selectively controlled based on the characteristics of the temporal and spatial modulation applied to the two-dimensional array of pixels.

In operation, each micro-mirror (in the array of individually controllable, tiltable mirror-pixels SLM 18) comprises an opto-mechanical element that can have at least two resting tilt states. For example, these states could be located at ±6° relative to the normal of the micro-mirror. When a given micro-mirror transitions from one resting position to the other resting position, such micro-mirror can pass through a singular angle with respect to the normal of the micro-mirror that is arranged to reflect the laser light in a direction back toward the lasing medium 14 and effect a lasing condition. Conversely, at angles other than such singular angle, the micro-mirror may be set to reflect the laser light away from lasing medium 14. That is, the laser light is not returned to the lasing medium. Accordingly, cavity loss of the laser can be temporally and spatially modulated based on the tilt state transitions of the micro-mirrors. Presently, a standard DMD may tilt though an arch of 12° in approximately 16 μsec, which is equivalent to approximately 125,000 RPM.

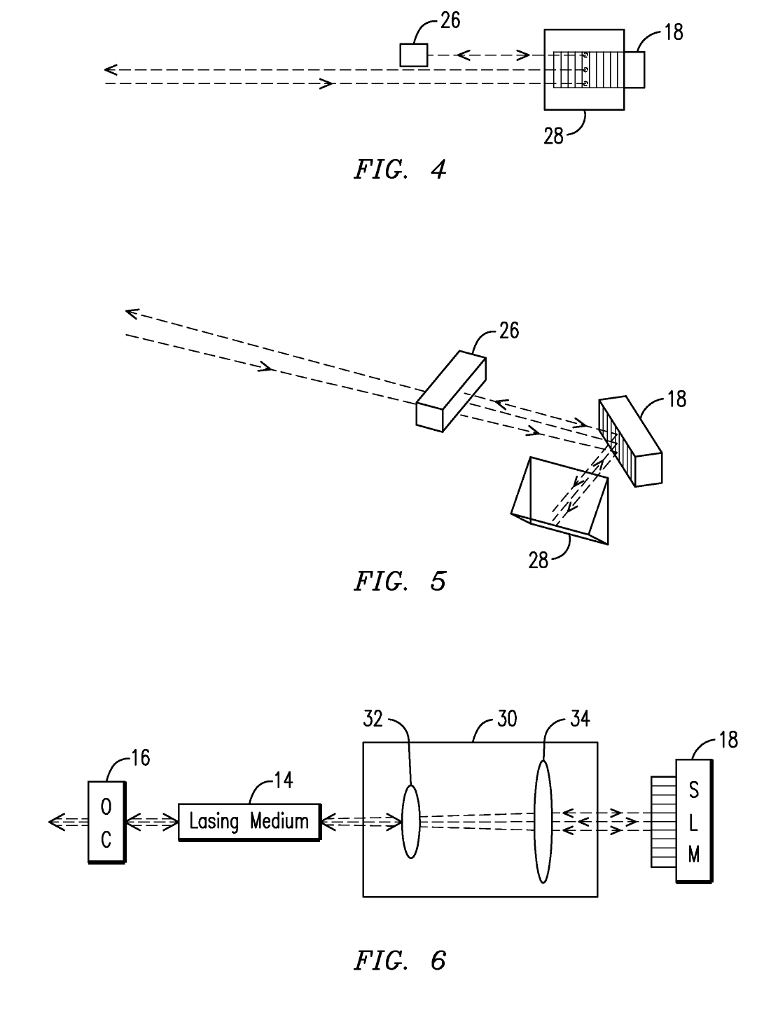

FIGS. 2-5 are respective schematic representations of embodiments that can optionally utilize one or more non-curved optical elements to provide angular magnification to beams incident on the two-dimensional array of micro-mirrors. This angular magnification is effective to narrow the temporal width of the generated optical pulses and thus is effective to increase the peak amplitude of such pulses. For example, as shown in FIG. 2, a non-curved optical reflector 24, such as mirror or prism, allows a laser beam to be incident twice on the micro-mirror pixels of SUM 18, which based on the law of reflection effectively provides a four times increase in the switching speed of the micro-mirror pixels relative to the baseline RPM of the SLM.

FIGS. 3, 4, and 5 respectively illustrate top, side and isometric views of an embodiment that utilizes a mirror 26 and prism 28, which in combination allow a laser beam to be incident four times on the micro-mirror pixels of SLM 18, which, once again, based on the law of reflection would effectively provide eight times increase in the switching speed of the micro-mirror pixels relative to the baseline RPM of the SLM.

FIGS. 6-8 are respective schematic representations of embodiments that utilize a telescope to provide angular magnification and further allow spreading a cross-section of a laser beam incident on the two-dimensional array of micro-mirrors. The present inventor has recognized that the angular deviation of a beam may be reduced by the magnification factor of a telescope when the beam is up-collimated and may be increased by the magnification factor of the telescope When the beam is down-collimated. For example, as shown in FIG. 6, a telescope 30 may include first and second lenses 32 and 34 arranged to provide an angular magnification (e.g., 10× increase in the switching speed of the micro-mirror pixels relative to the baseline RPM of the SLM) and moreover allows spreading the cross-section of beams incident on the two-dimensional array of micro-mirrors. This cross-sectional spread is conducive to provide an appropriate level of energy (e.g., below a predefined threshold level needed for reliable DMD operation) for the laser beam incident on the SLM 18 so that such a device is not damaged and functions with a substantially high level of reliability.

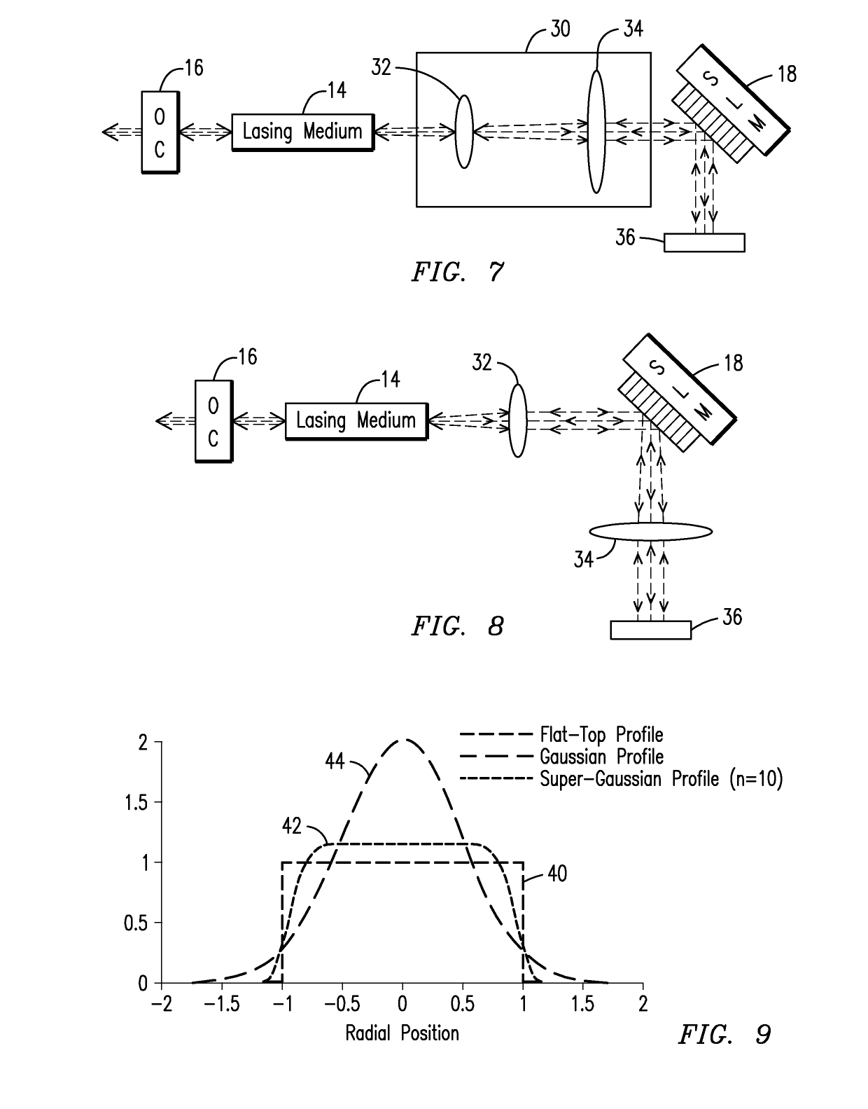

FIG. 7 illustrates a variation of the embodiment shown in FIG. 6, where a non-curved optical reflector 36, such as mirror or prism, allows the laser beam to be incident twice on the micro-mirror pixels of SLM 18, which based on the law of reflection provides further increase in the switching speed of the micro-mirror pixels relative to the baseline RPM of the SLM. FIG. 8 illustrates an embodiment where the telescopic arrangement includes SLM 18, which is disposed between lenses 32 and 34 in lieu of downstream of such lenses, as shown in FIGS. 6 and 7.

In one non-limiting application, the disclosed laser apparatus may be a medical laser apparatus configured to operate in a mid-wavelength infrared (MWIR) frequency range, capable of generating nanosecond-width pulses (e.g. a few nanoseconds, such as 10 nsec or less) in the MWIR. The temporally and spatially modulating of the two-dimensional array of pixels may be selected to: shape a profile of the generated optical pulses (e.g., forming pulses comprising a flat-top profile 40, a super-Gaussian profile 42 (a practical approximation to a flat-top profile) or a Gaussian profile 44, as shown in FIG. 9); reduce aberrations in the laser apparatus; and/or based on the type of medical procedure being performed with the laser apparatus. Example procedures may involve dental procedures, dermatological procedures, surgical procedures, etc.

While various embodiments have been described, it will be understood by those skilled in the an that various changes, omissions and/or additions may be made and equivalents may be substituted for elements thereof without departing from the spirit and scope of the embodiments. In addition, many modifications may be made to adapt a particular situation or material to the teachings of the embodiments without departing from the scope thereof. Therefore, it is intended that the embodiments not be limited to the particular embodiments being disclosed, but that all possible embodiments within the scope of the appended claims are considered. Moreover, unless specifically stated, any use of the terms first, second, etc., does not denote any order or importance, but rather the terms first, second, etc., are used to distinguish one element from another.

1. A laser apparatus for generating optical pulses comprising:
a laser cavity;
a spatial light modulator comprising a two-dimensional array of pixels arranged to provide Q-switching at a pixel level in the laser cavity; and
a controller connected to the spatial light modulator to temporally and spatially modulate the two-dimensional array of pixels to selectively control the Q-switching provided by the spatial light modulator.

2. The laser apparatus of claim 1, wherein the two-dimensional array of pixels comprises a two-dimensional array of rotatable micro-mirrors.

3. The laser apparatus of claim 2, further comprising at least one optical element arranged to provide angular magnification to beams incident on the two-dimensional array of micro-mirrors, the angular magnification effectively increasing a switching speed of the two-dimensional array of micro-mirrors.

4. The laser apparatus of claim 3, wherein said least one optical element comprises a non-curved optical element selected from the group consisting of a mirror, a prism and a combination of two or more of said non-curved optical elements.

5. The laser apparatus of claim 2, further comprising a telescope arranged to provide angular magnification and spread a cross-section of beams incident on the two-dimensional array of micro-mirrors, the angular magnification effectively increasing a switching speed of the two-dimensional array of micro-mirrors.

6. The laser apparatus of claim 2, further comprising at least one non-curved optical element optically coupled to the telescope to provide further angular magnification to the beams reflected by the two-dimensional array of micro-mirrors.

7. The laser apparatus of claim 1, wherein the laser cavity comprises a solid state lasing medium.

8. The laser apparatus of claim 1 configured to operate in a mid-wavelength infrared (MWIR) frequency range.

9. The laser apparatus of claim 8, wherein a width of the generated pulses comprises a few nanoseconds.

10. The laser apparatus of claim 1, wherein the laser cavity comprises a lasing medium selected from the group consisting of Nd:YAG (Neodymium doped Yttrium Aluminum Garnet); Er:YAG (Erbium doped Yttrium Aluminum Garnet); Yb:YAG (Ytterbium doped Yttrium Aluminum Garnet); Cr, Tm, Ho:YAG (Chromium, Thulium, Holmium doped Yttrium Aluminum Garnet; and Er, Cr:YSGG (Erbium, Chromium doped Yttrium Scandium Gallium Garnet).

11. A method for generating optical pulses, the method comprising:
performing Q-switching at a pixel level in a laser cavity with a spatial light modulator comprising a two-dimensional array of pixels; and
temporally and spatially modulating the two-dimensional array of pixels with a controller to selectively control the Q-switching performed by the spatial light modulator.

12. The method of claim 11, wherein the two-dimensional array of pixels comprises a two-dimensional array of rotatable micro-mirrors and further comprising angularly magnifying with a non-curved optical element beams incident on the two-dimensional array of micro-mirrors effectively increasing a switching speed of the two-dimensional array of micro-mirrors.

13. The method of claim 11, wherein the two-dimensional array of pixels comprises a two-dimensional array of rotatable micro-mirrors and further comprising angularly magnifying and spreading with a telescope a cross-section of beams incident on the two-dimensional array of micro-mirrors, the angular magnification effectively increasing a switching speed of the two-dimensional array of micro-mirrors.

14. The method of claim 13, further comprising optically coupling to the telescope at least one non-curved optical element to provide further angular magnification to the beams incident on the two-dimensional array of micro-mirrors.

15. The method of claim 11, wherein the temporally and spatially modulating of the two-dimensional array of pixels is selected to shape the generated optical pulses.

16. The method of claim 11 being performed in a laser apparatus operating in a mid-wavelength infrared (MWIR) frequency range.

17. The method of claim 16, wherein the laser apparatus comprises a laser apparatus for performing medical procedures, wherein the temporally and spatially modulating of the two-dimensional array of pixels is selected based on a type of procedure being performed with the medical laser apparatus.

18. The method of claim 11, wherein the temporally and spatially modulating of the two-dimensional array of pixels is selected to reduce optical aberrations in the laser apparatus.
